(19) United States
(12) Patent Application Publication
(10) Pub. No.: US 2018/0273165 A1
(43) Pub. Date: Sep. 27, 2018

(54) MULTIROTOR UNMANNED AERIAL VEHICLE

(71) Applicant: Shenyang Woozoom Technology Co., Ltd., Shenyang (CN)

(72) Inventors: Dalei SONG, Shenyang (CN); Wenbo SU, Shenyang (CN); Tianyu LIN, Shenyang (CN); Zhen ZHANG, Shenyang (CN); Sen MEI, Shenyang (CN)

(21) Appl. No.: 15/730,286

(22) Filed: Oct. 11, 2017

(30) Foreign Application Priority Data
Mar. 23, 2017 (CN) 201710178930.X

(51) Int. Cl. B64C 27/52; B64C 27/08; B64C 39/02

(52) U.S. Cl. CPC B64C 27/52; B64C 27/08; B64C 39/024; B64C 2201/127; B64C 2201/108; B64C 2201/042; B64C 2201/027

(57) ABSTRACT

The present disclosure relates to a multirotor unmanned aerial vehicle, comprising a fuselage, being provided with at least one support arm in a transverse penetrating manner, and a rotor, being disposed at each end of the support arm in a transverse tilting manner. When the unmanned aerial vehicle moves transversely, the tilting rotors can provide lift force for keeping the unmanned aerial vehicle at certain altitude and also provide power for transverse movement of the unmanned aerial vehicle, and meanwhile, the fuselage does not need to tilt, so that the unmanned aerial vehicle has the advantages of high response rate and high flight speed.

### CROSS-REFERENCE TO RELATED APPLICATIONS

The present application claims priority to Chinese Patent Application No. 201710178930.X, filed on Mar. 23, 2017, the entire contents of which are hereby incorporated by reference for all purposes.

### FIELD OF THE PRESENT DISCLOSURE

The present disclosure relates to the technical field of unmanned aerial vehicles, specifically relates to a kind of multirotor unmanned aerial vehicle.

### BACKGROUND OF THE PRESENT DISCLOSURE

The multirotor unmanned aerial vehicle is a multi-rotors unmanned aerial vehicle, and mainly differs from a fixed-wing unmanned aerial vehicle (e.g. a quadcopter) in the working principle, i.e., the rotating speeds of rotors of the quadcopter are changed by adjusting the rotating speeds of the four drive motors to change the lift force, thus controlling the attitude and position of the aircraft. The existing multirotor unmanned aerial vehicles have many problems, e.g., the overall structure is relatively heavy, and the stability is poor; besides, changes of the attitude and position of the unmanned aerial vehicle are realized via a flight control system by adjusting the rotating speeds of four brushless motors; when the unmanned aerial vehicle moves towards the four directions in a horizontal plane, the flight control system must adjust the rotating speeds of the motors so that the fuselage tilts a certain angle, and then the movements in the four directions (front, rear, left and right directions) can be performed; and under such a circumstance, if other task devices, e.g., a gimbal camera, an infrared device, etc., are mounted, these devices also will need to tilt correspondingly along with the tilting of the fuselage in order to ensure stable monitoring on a task object.

### SUMMARY OF THE PRESENT DISCLOSURE

An object of the present disclosure is to provide a multirotor unmanned aerial vehicle for solving the problem that the fuselage tilts when the unmanned aerial vehicle moves transversely.

In order to fulfill the above object, the present disclosure provides a multirotor unmanned aerial vehicle, comprising a fuselage, being provided with at least one support arm in a transverse penetrating manner, and a rotor, being disposed at each end of the support arm in a transverse tilting manner.

Optionally, a first tilting servo is mounted at the end of the support arm, the rotor is connected with a drive motor, the drive motor is fixed on a motor base, and the motor base is connected to the output end of the first tilting servo in a transverse tilting manner.

Optionally, the support arms comprise a first support arm, and a second support arm, spaced from the first support arm in the front-rear direction, which is parallel to the second support arm, and the rotors are uniformly distributed around the four corners of the fuselage.

Optionally, the fuselage comprises a bottom plate, a top plate, and a plurality of side plates, parallel to each other and standing between the bottom plate and the top plate, the side plates are provided with through holes through which the first support arm and the second support arm penetrate, and the bottom plate, the top plate and the side plates are made of carbon fiber.

Optionally, the fuselage comprises a fuselage carbon tube, extending longitudinally inside the fuselage, which is fixedly connected to the bottom plate, the top plate and the side plates respectively.

Optionally, the side plates comprise front side plates, and rear side plates spaced from each other in the front-rear direction, the first support arm penetrates through the rear side plates, and the second support arm penetrates through the front side plates.

Optionally, a plurality of connecting columns are supported between the top plate and the bottom plate at intervals.

Optionally, two batteries for supplying power for the unmanned aerial vehicle are disposed on the bottom plate, and disposed symmetrically to the longitudinal axis of the fuselage.

Optionally, a second tilting servo is fixed on the fuselage to drive the first support arm and the second support arm to rotate, so that the rotors can tilt longitudinally.

Optionally, the first support arm and the second support arm are connected with a connecting rod so as to rotate simultaneously.

Optionally, the periphery of the first support arm is closely sleeved with a first tube clip, the periphery of the second support arm is closely sleeved with a second tube clip, a second lug is formed on each of the first tube clip and the second tube clip respectively, a second joint is fixed at each of the two ends of the connecting rod respectively, and the second joints are connected with the second lugs in a rotatable manner.

Optionally, the output end of the second tilting servo is connected with a rocker arm, a first lug is formed on the first tube clip, a first joint is connected between the first lug and the rocker arm, and the two ends of the first joint are respectively connected with the first lug and the rocker arm in a rotatable manner.

Optionally, the first joint and the second joint on the first tube clip are formed integrally.

Optionally, the support arms are round tubes and are made of carbon fiber.

Optionally, the rotor is connected with a drive motor, the drive motor is fixed at the end of the support arm, and the electric wires of the drive motor are extended through the interior of the support arm to the fuselage.

Optionally, the drive motor is connected to an electronic speed controller, the electronic speed controller is disposed inside the support arm, and the electric wires of the electronic speed controller is extended through the interior of the support arm to the fuselage.

Optionally, an undercarriage is disposed on the support arm, and a damping structure is disposed on the undercarriage.

Optionally, the undercarriage is rod-like, and the damping structure is an elastic element fixed at one end of the undercarriage.

Optionally, based on the horizontal state of the rotors, the rotors are able to tilt 0°-10° inward and tilt 0°-45° outward.

Optionally, based on the horizontal state of the rotors, both the first support arm and the second support arm are able to tilt 0°-45° towards two directions.

Upon the above technical solutions, the rotors can tilt transversely, and when the unmanned aerial vehicle moves transversely, the tilting rotors can provide lift force for keeping the unmanned aerial vehicle at certain altitude and also provide power for transverse movement of the unmanned aerial vehicle, meanwhile, the fuselage does not need to tilt, so that the unmanned aerial vehicle has the advantages of high response rate and high flight speed.

Other features and advantages of the present disclosure will be elaborated in the following specific embodiments.

### BRIEF DESCRIPTION OF THE DRAWINGS

The accompanying drawings are used for providing further understanding of the present disclosure, constituting a part of the specification and interpreting the present disclosure together with the following specific embodiments, rather than limiting the present disclosure. In which:

FIG. 1 is a structural schematic diagram of a multirotor unmanned aerial vehicle according to an embodiment of the present disclosure;

FIG. 2 is a schematic diagram of an internal structure of the multirotor unmanned aerial vehicle according to an embodiment of the present disclosure;

FIG. 3 is a schematic principle diagram of support arm rotation according to an embodiment of the present disclosure;

FIG. 4 is a structural schematic diagram of a first tube clip in the embodiment shown in FIG. 2;

FIG. 5 is a structural schematic diagram of a second tube clip in the embodiment shown in FIG. 2;

FIG. 6 is a structural schematic diagram of a first joint in the embodiment shown in FIG. 2;

FIG. 7 is a structural schematic diagram of a second joint in the embodiment shown in FIG. 2;

FIG. 8 is a front view of a support arm and a rotor in the multirotor unmanned aerial vehicle according to an embodiment of the present disclosure;

FIG. 9 is a top view corresponding to FIG. 8;

FIG. 10 is a top view of the multirotor unmanned aerial vehicle shown in FIG. 1, with the top plate not shown;

FIG. 11 is a structural schematic diagram of a connector shown in FIG. 10.

### REFERENCE SIGNS

| | | |
|---|---|---|
| 100 fuselage | 110 bottom plate | 120 side plate |
| 121 front side plate | 122 rear side plate | 130 top plate |
| 140 connecting | 150 bearing pedestal | 200 rotor |
| column | | |
| 300 support arm | 310 first support arm | 320 second support arm |
| 400 connecting port | 500 second tilting servo | 610 first tube clip |
| 611 first lug | 612 second lug | 620 second tube clip |
| 630 connecting rod | 640 rocker arm | 650 first joint |
| 660 second joint | 700 undercarriage | 710 damping structure |
| 810 drive motor | 820 motor base | 830 first tilting servo |
| 840 servo base | 160 fuselage carbon tube | 170 connector |
| 171 sleeve part | 172 connecting part | |

### DETAILED DESCRIPTION OF THE EMBODIMENTS

The specific embodiments of the present disclosure will be elaborated below in combination with the accompanying drawings. It should be understood that the specific embodiments described herein are merely used for explaining and interpreting the present disclosure, rather than limiting the present disclosure.

In the present disclosure, unless stated otherwise, the nouns of locality such as “upper” and “lower” indicate upper and lower when the unmanned aerial vehicle is in a flat flight state, “left” and “right” indicate left and right when the unmanned aerial vehicle flies forward, and “inner” and “outer” are generally in view of the contours of corresponding parts themselves. It should be noted that the front and rear direction of flight of the unmanned aerial vehicle is defined according to its used habit, the length extension direction of the fuselage is the front and rear direction of flight of the unmanned aerial vehicle, and specifically in the present disclosure, the support arms extend in the side directions perpendicular to the front and rear direction of flight of the unmanned aerial vehicle. Besides, the terms “first”, “second” and the like used in the present disclosure are for distinguishing factors one from another, and do not have sequence or importance.

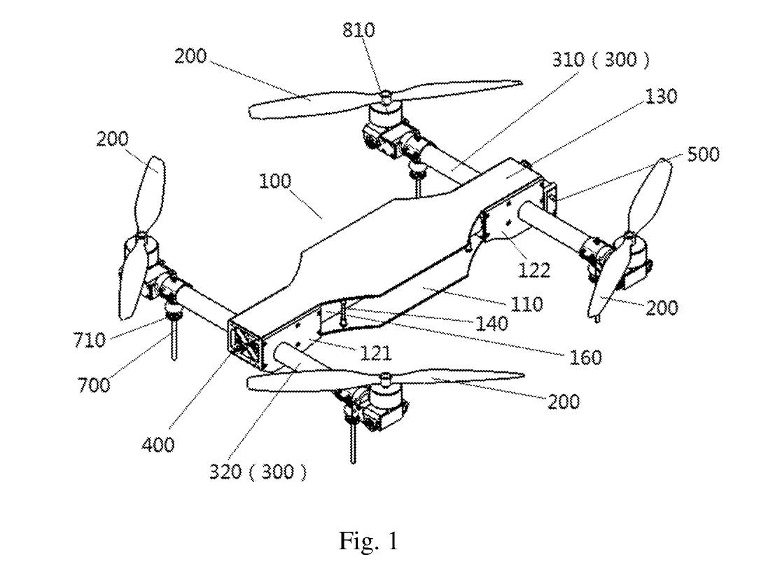

The multirotor unmanned aerial vehicle provided by the present disclosure is an unmanned aerial vehicle having multiple rotors but not having wings, and the flight attitude of the unmanned aerial vehicle is realized by the lift force change of each rotor and the like. Specifically, as shown in FIG. 1, at least one support arm 300 can transversely penetrate a fuselage 100, and a rotor 200 is disposed at each end of the support arm 300. The present disclosure will be described below by mainly based on a quadcopter as an example, i.e., a four-rotor unmanned aerial vehicle, including a fuselage 100 as well as a first rotor, a second rotor, a third rotor and a fourth rotor uniformly distributed at the four corners of the fuselage 100. As shown in FIGS. 1 and 8, the rotor 200 is connected with a drive motor 810 capable of driving the rotor 200 to rotate, and the drive motor 810 is installed at the end of the support arm 300 via a motor base 820.

In an embodiment shown by the present disclosure, the rotor 200 can be disposed at each end of the support arm 300 in a transverse tilting manner. It should be noted herein that the transverse tilting refers to tilting of the rotors towards the side directions of the fuselage, and besides, longitudinal tilting described below refers to tilting of the rotors towards the forward and backward directions. In this case, when the unmanned aerial vehicle moves transversely leftward and rightward, the rotors 200 tilt by certain angles towards two sides, the motors 200 can provide lift force for keeping the unmanned aerial vehicle at certain altitude and can also provide power for leftward and rightward movement of the unmanned aerial vehicle, and meanwhile, the fuselage 100 does not need to tilt, so that the resistance when the unmanned aerial vehicle flies is greatly reduced. When a mounted device is fixed on the fuselage 100, the mounted device can also run steadily, e.g., when a gimbal camera is mounted, it can ensure stable monitoring on a task object.

Specifically, referring to FIGS. 1, 8 and 9, a servo base 840 is installed at the end of the support arm 300, a first tilting servo 830 for driving the rotor 200 to tilt transversely is fixed on the servo base 840, and a motor base 820 is connected to the output end of the first tilting servo 830 in a transverse tilting manner, e.g., the motor base 820 is installed on an output rotating shaft of the first tilting servo 830. In this way, when the first tilting servo 830 acts, it can drive the motor base 820 and a drive motor 810 to tilt towards two directions, and drive the rotor 200 to tilt transversely together.

Moreover, in this embodiment, based on the horizontal state of the rotors 200, the rotors 200 are able to tilt 0°-10° inward and tilt 0°-45° outward. The flight attitude of the multirotor unmanned aerial vehicle in the present disclosure is completely controlled by the rotors 200, and it can ensure the dynamic property and stability of the unmanned aerial vehicle by controlling the tilting angles of the rotors 200 within a certain range, so that the unmanned aerial vehicle has enough lift force for staying in the air. Meanwhile, in order to prevent the rotors 200 tilting inward from colliding with the support arms 300, the inward tilting angles of the rotors 200 are relatively small. The inward herein refers to facing the longitudinal central axis of the unmanned aerial vehicle, and the outward refers to a direction opposite to the central axis. Specifically, e.g., when the unmanned aerial vehicle needs to advance transversely leftward at a full speed, the two rotors 200 on the left side tilt 45° outward, the two rotors 200 on the right side tilt 10° inward, and the power of the drive motors 810 on the left and right sides is simultaneously adjusted, so that the lift forces produced by the four rotors 200 are the same.

Further, in the above quadcopter, the support arms 300 include a first support arm 310 and a second support arm 320 spaced from each other in the front-rear direction, wherein the first support arm 310 is parallel to the second support arm 320, and the rotors 200 are uniformly distributed at the four corners of the fuselage 100, and in this way, the four rotors 200 are located at the four corners of a rectangular region, so that the unmanned aerial vehicle is stable in structure and can fly steadily.

As shown in FIG. 1, the fuselage 100 of the unmanned aerial vehicle provided by the present disclosure can include a bottom plate 110, a top plate 130 and a plurality of side plates 120, parallel to each other and standing between the bottom plate 110 and the top plate 130, wherein the side plates 120 are provided with through holes through which the first support arm 310 and the second support arm 320 penetrate. Such a hollow structure encircled by the bottom plate 110, the side plates 120 and the top plate 130 has the advantages of compact structure and high stability, and the unmanned aerial vehicle can be placed in the hollow structure. The bottom plate 110, the top plate 130 and the side plates 120 are made of carbon fiber, so that the overall weight can be reduced and the overall strength can also be improved.

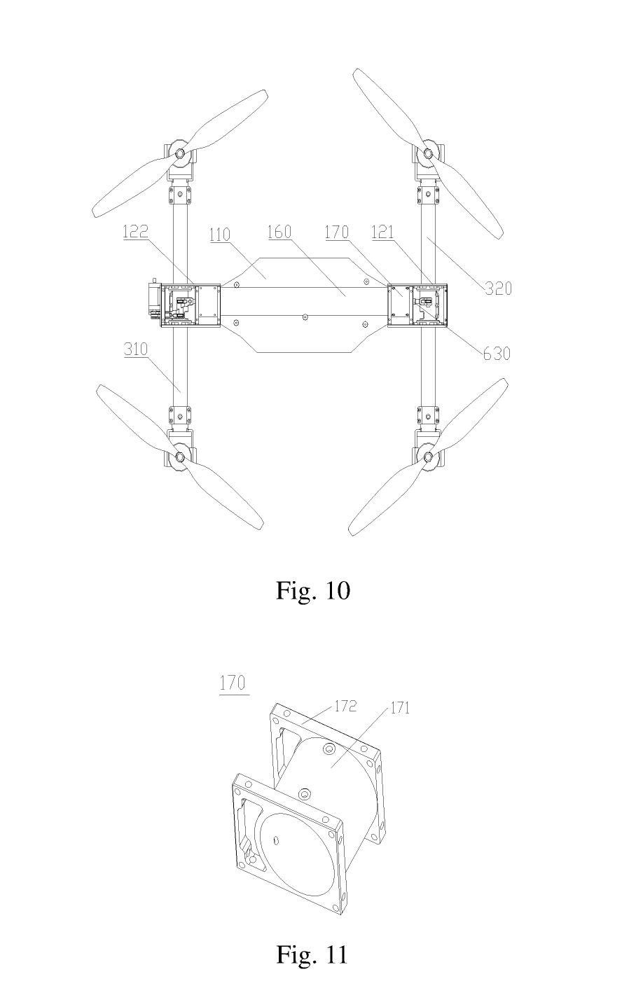

Further, the fuselage 100 includes a fuselage carbon tube 160 extending longitudinally inside the fuselage, and the fuselage carbon tube 160 is fixedly connected to the bottom plate 110, the top plate 130 and the side plates 120 respectively. In combination with said structure of the fuselage 100 encircled by the bottom plate 110, the top plate 130 and the side plates 120, the fuselage carbon tube 160 is disposed inside the fuselage 100, and a majority of the bending moment at the fuselage 100 produced by the four rotors 200 is transferred by the fuselage carbon tube 160 in the flight process of the unmanned aerial vehicle, and a minority of the bending moment is transferred by the carbon plates such as the bottom plate 110 and the like, so that the fuselage 100 has a good anti-torque section, and the stability of the overall structure of the unmanned aerial vehicle in the flight process is guaranteed. Specifically, as shown in FIG. 10, a connector 170 can be fixed at each of the two ends of the fuselage carbon tube 160 respectively, and the connectors 170 are provided with mounting holes so as to be fixed on the bottom plate 110, the top plate 130 and the side plates 120, e.g., in a threaded connection manner. In one embodiment, as shown in FIG. 11, the connector 170 can include a sleeve part 171 fixedly sleeved on the periphery of the fuselage carbon tube 160 and a connecting part 172 located outside the sleeve part 171 and used for fixing with the bottom plate 110, the top plate 130 and the side plates 120, wherein the connecting part 172 is of a flat plate structure, and can be attached to and closely connected to the bottom plate 110, the top plate 130 and the side plates 120. The specific structures of the connectors 170 are not limited in the present disclosure, and in other embodiments, the connectors 170 can be adaptively adjusted according to the specific structures of the fuselage carbon tube 160, the bottom plate 110, the top plate 130, the side plates 120 and other components. The connectors 170 may be aluminum alloy plates, and are thus low in cost and light.

Further, the side plates 120 include front side plates 121 and rear side plates 122 spaced from each other in the front-rear direction, wherein the first support arm 310 penetrates through the rear side plates 122, and the second support arm 320 penetrates through the front side plates 121. By designing the side plates 120 into split structures, the overall weight of the unmanned aerial vehicle can be further reduced, and the shape design of the fuselage is facilitated. For example, as shown in FIG. 1, the top plate 130 and the bottom plate 110 form a structure widened from front and back to middle, and the front side plates 121 and the rear side plates 122 can be installed at the narrow positions of the top plate 130 and the bottom plate 110 and are flat straight plates, so the machining is convenient. Further, in order to improve the stability of the fuselage 100, a plurality of connecting columns 140 are supported between the top plate 130 and the bottom plate 110 at intervals to avoid compressive deformation of the top plate 130 or the bottom plate 110, and the connecting columns 140 may be made of aluminum alloy and are thus low in cost, light and high in stability.

Further, the first support arm 310 and the second support arm 320 respectively transversely penetrate through the fuselage 100 in a rotatable manner, and the rotors 200 fixed at two ends of the first support arm 310 and two ends of the second support arm 320 respectively can tilt longitudinally. Under the condition that the support arms 300 can rotate, the rotors 200 can rotate together with the support arms 300, in this way, when the unmanned aerial vehicle moves longitudinally forward and backward, the rotors 200 tilting certain angles can provide lift force for keeping the unmanned aerial vehicle at certain altitude and provide power for forward and backward movement of the unmanned aerial vehicle, and meanwhile, the fuselage 100 does not need to tilt, so that the unmanned aerial vehicle has the advantages of high response rate and high flight speed, and the resistance when the unmanned aerial vehicle flies is greatly reduced.

Besides, as shown in FIG. 1, the fuselage 100 is provided with connecting ports 400 for fixing mounted devices. When the unmanned aerial vehicle moves longitudinally forward and backward, the fuselage 100 is kept in a horizontal state, so that the mounted devices can also run steadily, e.g., when a gimbal camera is mounted, it can ensure stable monitoring on a task object. The mounted devices may be, for example, a gimbal camera, an infrared device, a laser radar, etc.

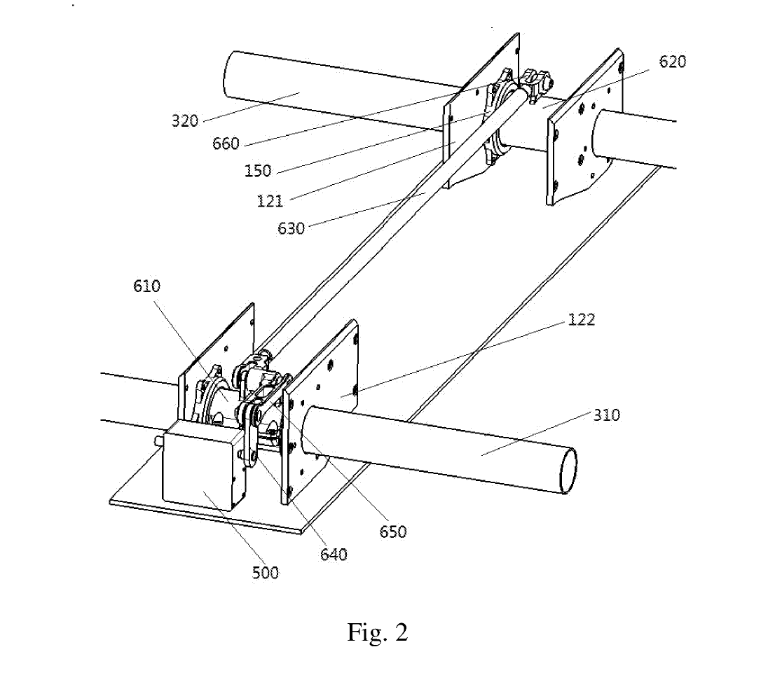

As shown in FIG. 2, bearing pedestals 150 are coaxially disposed in the through holes of the side plates 120, and the first support arm 310 and the second support arm 320 are installed on the bearing pedestals 150 via bearings, so that the first support arm 310 and the second support arm 320 rotate steadily to improve the response speeds of the rotors 200.

As shown in FIGS. 1-3, a second tilting servo 500 is fixed on the fuselage 100 to drive the first support arm 310 and the second support arm 320 to rotate so that the rotors can tilt longitudinally. There may be two second tilting servos 500 which respectively control the first support arm 310 and the second support arm 320, and under such a circumstance, the two second tilting servos 500 are designed by circuit coupling to ensure the controllable lift force of the four rotors 200; there may be one second tilting servo 500 which drives one of the first support arm 310 and the second support arm 320, and under such a circumstance, the first support arm 310 and the second support arm 320 can move synchronously via a link mechanism, i.e., the first rotor, the second rotor, the third rotor and the fourth rotor can tilt forward and backward in the same direction.

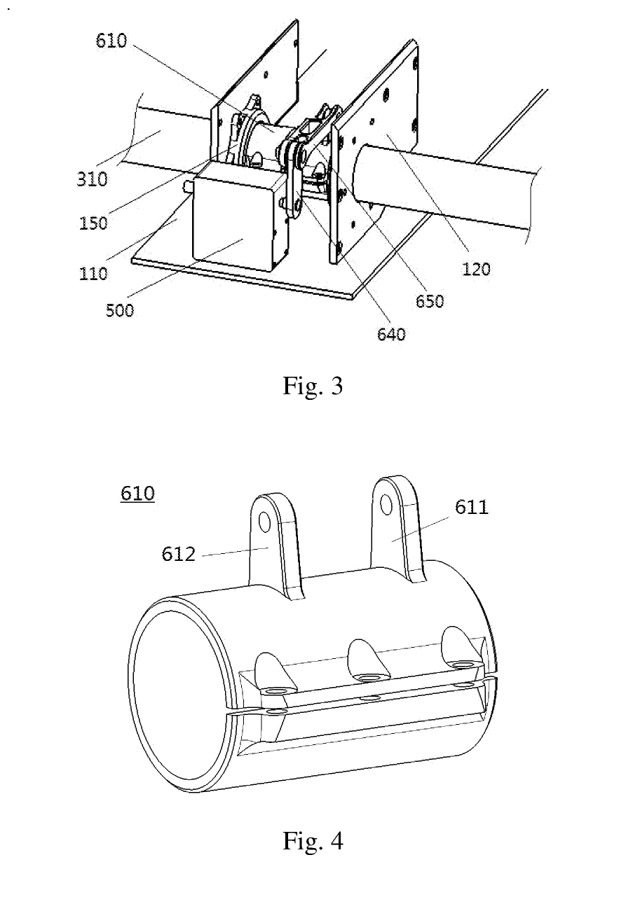

The second tilting servo 500 can drive the support arms 300 in multiple forms. Taking the situation that the second tilting servo 500 drives the first support arm 310 as an example, as shown in FIGS. 3, 4 and 6, the output end of the second tilting servo 500 is connected with a rocker arm 640, and the periphery of the first support arm 310 is closely sleeved with a first tube clip 610 so that the first tube clip 610 and the first support arm 310 can rotate simultaneously, meanwhile, a first lug 611 is formed on the first tube clip 610, and a first joint 650 is connected between the first lug 611 and the rocker arm 640, and two ends of the first joint 650 are respectively connected with the first lug 611 and the rocker arm 640 in a rotatable manner. In this case, the second tilting servo 500 drives the rocker arm 640 to rotate, and the rocker arm 640 drives the first tube clip 610 to rotate, so that the first support arm 310 can rotate.

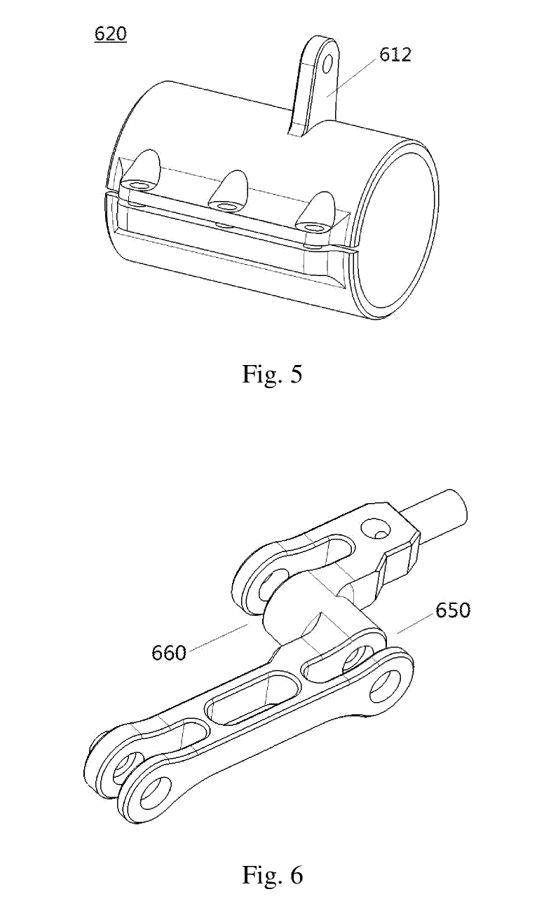

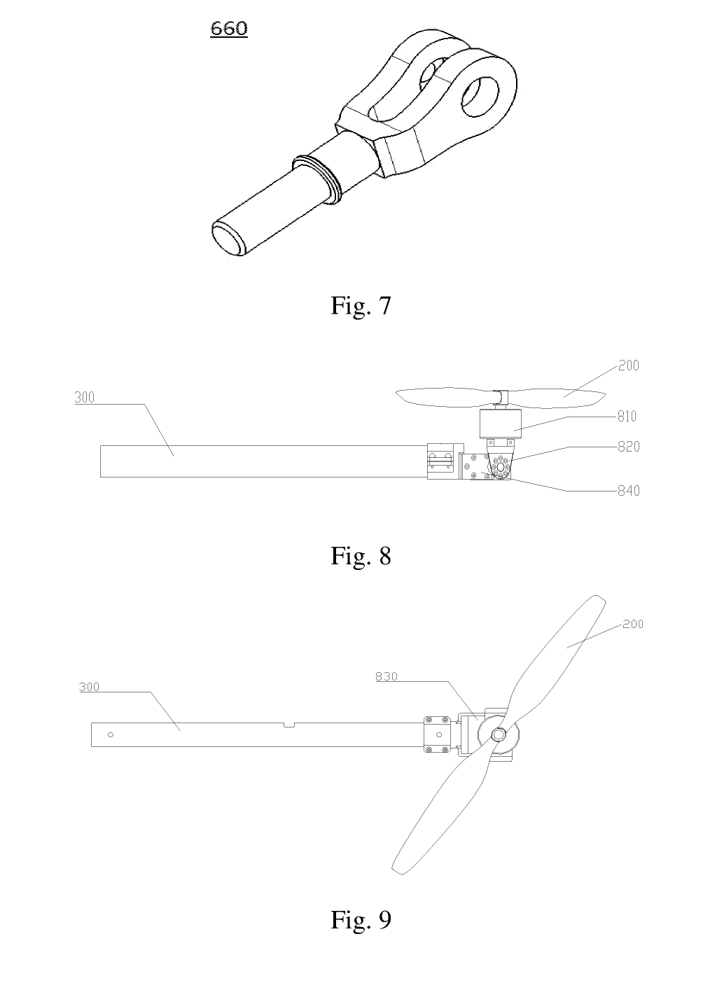

As shown in FIGS. 2-7, in the presence of only one second tilting servo 500, the aforementioned link mechanism may include a connecting rod 630 connected between the first support arm 310 and the second support arm 320. Specifically, the periphery of the first support arm 310 is closely sleeved with the first tube clip 610 so that the first tube clip 610 and the first support arm 310 can rotate simultaneously, and the periphery of the second support arm 320 is closely sleeved with a second tube clip 620 so that the second tube clip 620 and the second support arm 320 can rotate simultaneously, while a second lug 612 is formed on each of the first tube clip 610 and the second tube clip 620 respectively, and a second joint 660 is fixed at each of the two ends of the connecting rod 630 respectively, and the second joints 660 are respectively connected with the second lugs 612 on the two support arms 300 in a rotatable manner. Thus, the two support arms 300 can rotate simultaneously. On the basis that the second tilting servo 500 drives the first support arm 310 and through the coordination of the connecting rod 630, the rocker arm 640, the first joint 650, the second joints 660, the first tube clip 610 and the second tube clip 620 are connected rigidly so that after the position relations between the components are adjusted during assembly, when the unmanned aerial vehicle tilts forward and backward in the flight process, the first tube clip 610 and the second tube clip 620 can respond synchronously, and the first support arm 310 and the second support arm 320 can rotate synchronously, so that the operating precision is improved. Under such a situation, the second tilting servo 500 is installed at the rear end of the fuselage 100, e.g., fixed on the bottom plate 110, so that the internal space of the fuselage 100 is saved for placing other parts. Besides, in order to ensure the flight stability of the unmanned aerial vehicle, the second tilting servo 500 may be disposed on the longitudinal axis of the fuselage 100 to avoid overall center-of-gravity shift.

In addition, in the above embodiment, the connecting rod 630 extends forward and backward, and the fuselage carbon tube 160 also extends forward and backward, so that the connecting rod 630 can be disposed inside the fuselage carbon tube 160 to improve the utilization rate of the space.

Further, as shown in FIGS. 2 and 6, the first joint 650 and the second joint 660 on the first tube clip 610 are formed integrally, thus reducing the cost. Referring to FIG. 6, at the joint of the first joint 650 and the second joint 660, they are respectively connected to the first lug 611 and the second lug 612; and at the separated parts of the first joint 650 and the second joint 660, they are respectively connected to the rocker arm 640 and the connecting rod 630.

Furthermore, the connecting rod 630, the first support arm 310 and the second support arm 320 may be respectively round tubes and are made of carbon fiber, and thus have light weight and high strength.

Since the flight attitude of the multirotor unmanned aerial vehicle in the present disclosure is completely controlled by the rotors 200, in order that the unmanned aerial vehicle has enough lift force for staying in the air, based on the horizontal state of the rotors 200, both the first support arm 310 and the second support arm 320 are able to tilt 0°-45° towards the front and rear directions, thus ensuring the dynamic property and stability of the unmanned aerial vehicle. The tilting angles of the first support arm 310 and the second support arm 320 are controlled by the second tilting servo 500, and when the second tilting servo 500 controls the rocker arm 640 to swing, the rocker arm 640 can swing 0°-45° towards the two directions.

It should be noted that the above two embodiments can be combined, i.e., the rotors 200 can tilt longitudinally and transversely, so that all-directional tilting of the rotors 200 of the unmanned aerial vehicle is realized. When the unmanned aerial vehicle moves towards each direction, the fuselage 100 is kept horizontal all the time, so that the requirement for the degrees of freedom of the carried task devices is reduced a lot, and more task devices can be carried to meet multiple task requirements. Besides, no matter the rotors 200 tilt longitudinally or transversely, they make quicker response after receiving an instruction of a flight control system, so that the efficiency of task actions is improved.

Moreover, in the above embodiments of the present disclosure, the longitudinal tilting of the four rotors 200 is realized via link components such as the support arms 300, the connecting rod 630, the rocker arm 640 and the like, and the transverse tilting thereof is realized via tilting structures independently installed at the ends of the support arms 300. In other embodiments, the link tilting of the four rotors 200 may also be transverse link, e.g., rotatable supporting rods extending forward and backward are disposed on two sides of the fuselage 100, the rotors 200 are installed at two ends of the supporting rods, and the two supporting rods are connected by a structure such as the connecting rod 630 in the present disclosure or the like, so that the consistency of transverse tilting of the four rotors 200 is realized. Other structures enabling the rotors 200 to tilt in the same direction are not redundantly described herein one by one, and they fall into the protection scope of the present disclosure as long as the rotors 200 tilt in the same direction by linkage. By adding the link components between the rotors 200, the rotors 200 can act synchronously, and can thus make a quick response after receiving an action signal.

Further, when the first support arm 310 and the second support arm 320 in the present disclosure are of tubular structures such as the round carbon tubes described above, electric wires of the drive motor 810 can extend through the interior of each of the support arm 300 to the fuselage 100 to communicate with a circuit, so that the compactness and attractiveness of the appearance are ensured while the space is sufficiently utilized.

Further, the drive motor 810 is connected to an electronic speed controller to change the rotating speeds of the rotors 200, and the electronic speed controller is disposed inside the support arm 300, and similar to the drive motor 810, electric wires of the electronic speed controller is extended through the interior of the support arm 300 to the fuselage 100, so that the compactness and attractiveness of the appearance are ensured while the space is sufficiently utilized. The electronic speed controller is installed close to the drive motor 810, thereby ensuring the structure compact.

In addition, two batteries for supplying power for the unmanned aerial vehicle are disposed on the bottom plate 110 of the fuselage 100 to ensure the cruising ability of the unmanned aerial vehicle. The two batteries are disposed symmetrically to the longitudinal axis of the fuselage 100, and are located on two sides of the fuselage carbon tube 160 and between the top plate 130 and the bottom plate 110, thus controlling the overall center of gravity from being changed too much on the longitudinal axis of the fuselage 100.

As shown in FIG. 1, an undercarriage 700 is disposed on each support arm 300 of the unmanned aerial vehicle provided by the present disclosure, and a damping structure 710 is disposed on the undercarriage 700, thus absorbing the majority of impact borne when the unmanned aerial vehicle lands. The undercarriages 700 may be vertically disposed as rod-like structures, and are uniformly distributed at the ends of the support arms 300, thereby ensuring the landing stability of the unmanned aerial vehicle. The damping structure 710, for example, may be an elastic element such as a rubber ball or a spring, and the elastic element is fixed at the end of the rod-like undercarriage 700 close to the fuselage 100.

The preferred embodiments of the present disclosure are described in detail above in combination with the accompanying drawings, but the present disclosure is not limited to the specific details in the above embodiments, many simple modifications may be made to the technical solutions of the present disclosure within the technical consideration scope of the present disclosure, and all these simple modifications fall into the protection scope of the present disclosure. In addition, it should be noted that the specific technical features described in the above specific embodiments may be combined in any appropriate manner without contradictions, and in order to avoid unnecessary repetition, various possible combination manners would not be described in the present disclosure. Moreover, various different embodiments of the present disclosure can be combined randomly, and they should be regarded as the contents of the present disclosure as long as they do not go against the thought of the present disclosure.

1. A multirotor unmanned aerial vehicle, comprising:
a fuselage, being provided with at least one support arm in a transverse penetrating manner, and
a rotor, being disposed at each end of the support arm in a transverse tilting manner.

2. The multirotor unmanned aerial vehicle of claim 1, wherein a first tilting servo is mounted at the end of the support arm, the rotor is connected with a drive motor, the drive motor is fixed on a motor base, and the motor base is connected to the output end of the first tilting servo in a transverse tilting manner.

3. The multirotor unmanned aerial vehicle of claim 1, wherein the support arms comprise:
a first support arm, and
a second support arm, spaced from the first support arm in the front-rear direction, which is parallel to the second support arm, and the rotors are uniformly distributed around the four corners of the fuselage.

4. The multirotor unmanned aerial vehicle of claim 3, wherein the fuselage (100) comprises:
a bottom plate,
a top plate, and
a plurality of side plates, parallel to each other and standing between the bottom plate and the top plate, the side plates are provided with through holes through which the first support arm and the second support arm penetrate, and the bottom plate, the top plate and the side plates are made of carbon fiber.

5. The multirotor unmanned aerial vehicle of claim 4, wherein the fuselage comprises
a fuselage carbon tube, extending longitudinally inside the fuselage, which is fixedly connected to the bottom plate, the top plate and the side plates respectively.

6. The multirotor unmanned aerial vehicle of claim 4, wherein the side plates comprise:
front side plates, and
rear side plates spaced from each other in the front-rear direction, the first support arm penetrates through the rear side plates, and the second support arm penetrates through the front side plates.

7. The multirotor unmanned aerial vehicle of claim 4, wherein a plurality of connecting columns are supported between the top plate and the bottom plate at intervals.

8. The multirotor unmanned aerial vehicle of claim 4, wherein two batteries for supplying power for the unmanned aerial vehicle are disposed on the bottom plate, and disposed symmetrically to the longitudinal axis of the fuselage.

9. The multirotor unmanned aerial vehicle of claim 3, wherein a second tilting servo is fixed on the fuselage to drive the first support arm and the second support arm to rotate, so that the rotors can tilt longitudinally.

10. The multirotor unmanned aerial vehicle of claim 9, wherein the first support arm and the second support arm are connected with a connecting rod so as to rotate simultaneously.

11. The multirotor unmanned aerial vehicle of claim 10, wherein the periphery of the first support arm is closely sleeved with a first tube clip, the periphery of the second support arm is closely sleeved with a second tube clip, a second lug is formed on each of the first tube clip and the second tube clip respectively, a second joint is fixed at each of the two ends of the connecting rod respectively, and the second joints are connected with the second lugs in a rotatable manner.

12. The multirotor unmanned aerial vehicle of claim 11, wherein the output end of the second tilting servo is connected with a rocker arm, a first lug is formed on the first tube clip, a first joint is connected between the first lug and the rocker arm, and the two ends of the first joint are respectively connected with the first lug and the rocker arm in a rotatable manner.

13. The multirotor unmanned aerial vehicle of claim 12, wherein the first joint and the second joint on the first tube clip are formed integrally.

14. The multirotor unmanned aerial vehicle of claim 1, wherein the support arms are round tubes and are made of carbon fiber.

15. The multirotor unmanned aerial vehicle of claim 14, wherein the rotor is connected with a drive motor, the drive motor is fixed at the end of the support arm, and the electric wires of the drive motor are extended through the interior of the support arm to the fuselage.

16. The multirotor unmanned aerial vehicle of claim 15, wherein the drive motor is connected to an electronic speed controller, the electronic speed controller is disposed inside the support arm, and the electric wires of the electronic speed controller is extended through the interior of the support arm to the fuselage.

17. The multirotor unmanned aerial vehicle of claim 1, wherein an undercarriage is disposed on the support arm, and a damping structure is disposed on the undercarriage.

18. The multirotor unmanned aerial vehicle of claim 17, wherein the undercarriage is rod-like, and the damping structure is an elastic element fixed at one end of the undercarriage.

19. The multirotor unmanned aerial vehicle of claim 1, wherein based on the horizontal state of the rotors, the rotors are able to tilt 0°-10° inward and tilt 0°-45° outward.

20. The multirotor unmanned aerial vehicle of claim 9, wherein based on the horizontal state of the rotors, both the first support arm and the second support arm are able to tilt 0°-45° towards two directions.
